(19) United States
(12) Patent Application Publication
(10) Pub. No.: US 2005/0042068 A1
(43) Pub. Date: Feb. 24, 2005

(54) Forklift with stabilizing forks

(76) Inventor: Ronald Ehmen, Rantoul, IL (US)

Correspondence Address: KNECHTEL DEMEUR & SAMLAN;ATTN: ALAN B. SAMLAN, 222 S. RIVERSIDE, SUITE 1410, CHICAGO, IL, 60606, US

(21) Appl. No.: 10/641,948

(22) Filed: Aug. 18, 2003

(51) Int. Cl. B66F 1/00

(52) U.S. Cl. 414/661

(57) ABSTRACT

A forklift that can move itself and loads between two heights uses multiple sets of forks to stabilize the forklift while raising and lowering loads. A conventional set of pallet forks is mounted on a forward and rearward horizontally moveable chassis. Upper stabilizing forks are selectively extended forward from the forklift chassis to rest on a surface located below the load being moved. Lower stabilizing forks extend downward and forward from the bottom of the forklift for additional stability. A set of extendable front wheels extends forward to stabilize the forklift when moving the forklift between two heights. The pallet forks are mounted on a deck that can be raised and lowered. There are two independent drive systems that move the forklift depending on whether the main drive system is on the ground or elevated. The entire forklift can be remote controlled.

### BACKGROUND OF THE INVENTION

This invention relates to a new and improved forklift that uses multiple sets of forks to stabilize the forklift when loads are raised and lowered. A unique rear wheel drive and scissors lifting mechanism operate in conjunction with a set of extendable front wheels to lift the forklift onto and off of a truck or loading dock.

The delivery of products, inventory, and merchandise to the user represents a critical part of the economy. The method of delivery depends to a large extent on the item delivered. Large industrial equipment may be shipped one piece at a time, due to the fact that the piece may be of size and or weight to fill a trailer. Smaller items may be packed in cartons and shipped on pallets. This is one of the most commonly used means of delivering items to stores and warehouses. This invention is particularly well suited for the delivery of inventory and merchandise to small resellers, distributors or retail stores that have limited material receiving and handling equipment and equipment handling facilities.

Each material delivery system has it's own unique set of problems. For example, routine lifting, pushing or pulling boxes onto and off of trucks result in numerous job related injuries. This results in time off for injured employees, or may even result in permanent injuries and long term disability. Even with the use of handcarts or power-assisted carts, the number of injuries is still significant. This is especially true when moving boxes off of a truck to the warehouse or storage area.

The floor of a delivery truck is several feet above the ground. If a truck dock is available, the materials can be transferred from the truck to the dock by means of hand-carts, forklifts or other wheeled means. The material does not have to be moved from the truck floor to ground level and then moved to its storage location. There is a problem when moving loaded pallets from a truck to a warehouse or store when there is no truck level dock. Here the pallets or boxes must first be lowered to ground level. This is either done by a hydraulic tailgate or by moving the boxes to the rear of the truck and then removing them with a forklift, if available. Many stores do not want to invest in forklifts, and thus move the boxes by handcarts. This is dangerous in that it often leads to worker injuries. Furthermore, the more a product is moved, the greater the chance of damaging it. This also presents additional problems of moving the product over substantial distances if the truck is far from the storage area. Other problems arise in moving handcarts over ice, snow, gravel or other irregular surfaces. The wheels of handcarts do not easily move over soft or irregular surfaces and are inherently unstable. A handcart also limits the size of the load carried. If a forklift is used, other problems arise. The size of the receiving doors at the storage area may be too small to receive a large forklift or the forklift may not be able to maneuver to move the load to the desired storage location.

Another problem with conventional forklifts is that the operator sits on a seat at the back of the forklift, which increases the size of the forklift. This is a great detriment if the forklift is stored on the truck as it reduces the amount of freight that the truck can carry. Ideally, if the operator's seat can be removed, the size of the forklift can be substantially reduced. This can be achieved if a remote control device controls all operations of the forklift. This allows the operator to stand remotely from the forklift and reduces the size of the forklift.

In the past there has never been a versatile forklift that has its own internal lifting system that can lift the forklift onto a truck, place the load on the forks, back itself off of the truck, and lower itself to the ground. Furthermore the prior art does not teach a remote control operator to control the movement of the forklift and the forks. There also has never been a forklift that uses multiple sets of forks to stabilize the forklift in different situations. The art has addressed several types of forklifts, but none of them solve the problems addressed by applicant.

For example, U.S. Pat. No. 4,061,237 issued on Dec. 6, 1977 to Austin et al. discloses a mechanism for storing a forklift on top of a raised platform such as a loading dock or the floor of a truck. The fork tines are received in stirrups that in turn lift the forklift to the desired level. However, this unit does not have any means to enter onto the truck, remove a load and lower itself to the ground while still supporting the load on the forks. It also does not provide additional sets of stabilizing forks that are extended to stabilize the forklift when removing loads.

U.S. Pat. No. 4,571,139 issued on Feb. 18, 1986 to Moseley et al. and illustrates a forklift that is collapsible and can be stored on a freight handling truck. However this device cannot raise and lower itself onto a trailer while also carrying a load on the forks. This patent discloses the use of a top clamp above the lifting forks for stability. However the top clamp does not move forward and rearward, but only pivots to a clamping position and can move up and down. The patent also does not illustrate a remote control operating mechanism.

U.S. Pat. No. 5,409,346 issued Apr. 25, 1995 to Grether illustrates a forklift that can lift itself onto a truck and back itself off of the truck. It has driven front wheels and a rear wheel mechanism that lifts the rear of the forklift. Through the movement of the rear axle assembly in conjunction with the movement of the front wheel assembly and the forks, the forklift remains stable and moves onto and off of the truck. No remote control of the forklift is disclosed.

U.S. Pat. No. 5,879,124 issued on Mar. 9, 1999 to Brouwer et al. and illustrates a collapsible forklift that has three frame assemblies. This allows the vehicle frame to be shortened for transport. It does not have multiple sets of forks for stability nor does it have any means for raising or lowering itself onto and off of a truck.

### SUMMARY OF THE INVENTION

Applicant's invention provides a solution to the problem of raising and lowering a forklift onto and off of a trailer without using external means. It also solves the problem of stabilizing a forklift when lifting loads of various height and weight. The forklift is safely operated by remote control so that the risk to the operator is minimized if the device falls off a truck.

Applicant's invention provides a forklift with three sets of forks. There is a set of conventional forks or pallet forks used to lift and load pallets or other stacked items. There is an upper set of stabilizing forks that are selectively extended forward from the forklift chassis. These extend and rest on a load located on a lower pallet than the one being moved, thereby providing stability. There is a lower set of stabilizing forks that extend downward and forward from the bottom of the forklift chassis. These are used when additional stability is required when lifting a load with the pallet forks. There is also a set of extendable front wheels that extend forward from the forklift chassis that is used to stabilize the forklift when moving between two heights.

The pallet fork is mounted on a moveable deck that provides forward and rearward movement of the pallet fork. The forklift has two sets of driving wheels to move it along the ground. The main drive is an endless track that moves over varying terrain with ease. The main drive is mounted to the chassis below the deck. The second drive is connected to the rear wheels and moves the forklift when the main drive is not able to, such as when the main drive is raised above the ground by the lift mechanism. The deck can be raised by means of a lift mechanism. The rear wheels are connected to the chassis by means of telescoping members that are hydraulically operated. The telescoping members allow the rear wheels to remain on the ground while the deck and pallet fork are raised to a second level. By selectively operating the lift mechanism, telescoping members, and driving wheels, the forklift can be moved between two different heights.

### OBJECTS AND ADVANTAGES OF THE INVENTION

It is an object of the invention to provide a forklift having multiple sets of extendable forks. The advantage is that the multiple sets of forks provide for increased stability of the forklift when retrieving loads.

It is another object of the invention to provide a new and improved forklift that has a pallet fork mounted on a horizontally moveable deck allowing the pallet fork to move forward and backward to retrieve loads.

Another object is to provide a forklift that can lift and lower itself between two different horizontal levels. A related object is to provide a forklift that can move itself between levels while holding a load. Yet another related object is to provide a forklift that has telescoping members to raise and lower the forklift between the different levels.

Still another object is to provide a forklift that can be operated by remote control. This provides a safe operating environment for the operator.

A further object is to provide a forklift that has an endless track drive system for moving the forklift over uneven ground. Still another object is to provide a forklift that has a second drive system connected to the rear wheels to move the forklift even when the endless track is not engaged or is not in contact with the ground.

These and other objects and advantages will be apparent when reading the Detailed Description of the Drawings and Description of the Preferred Embodiment.

### DETAILED DESCRIPTION OF THE DRAWINGS

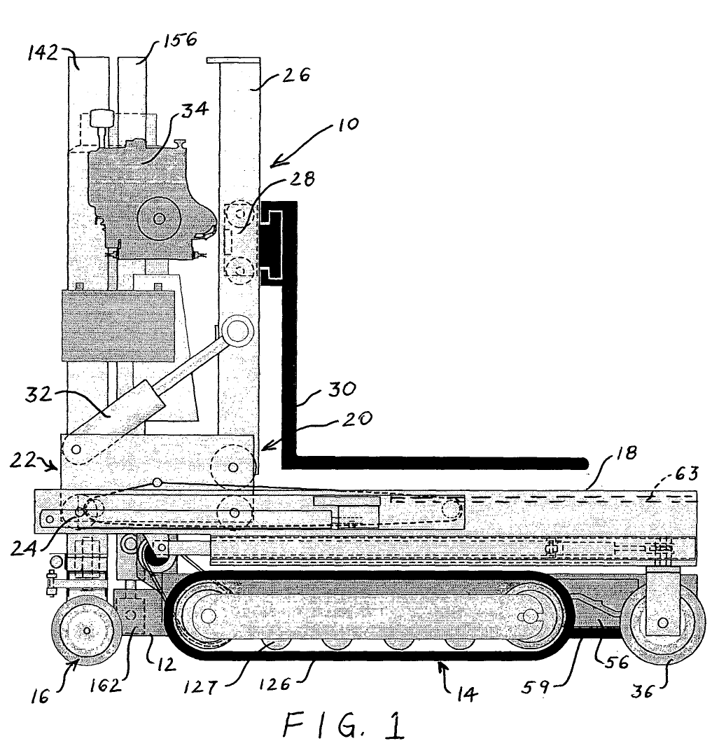

FIG. 1 is a side elevation view of the inventive forklift.

FIG. 2 is a front elevation view of the inventive forklift.

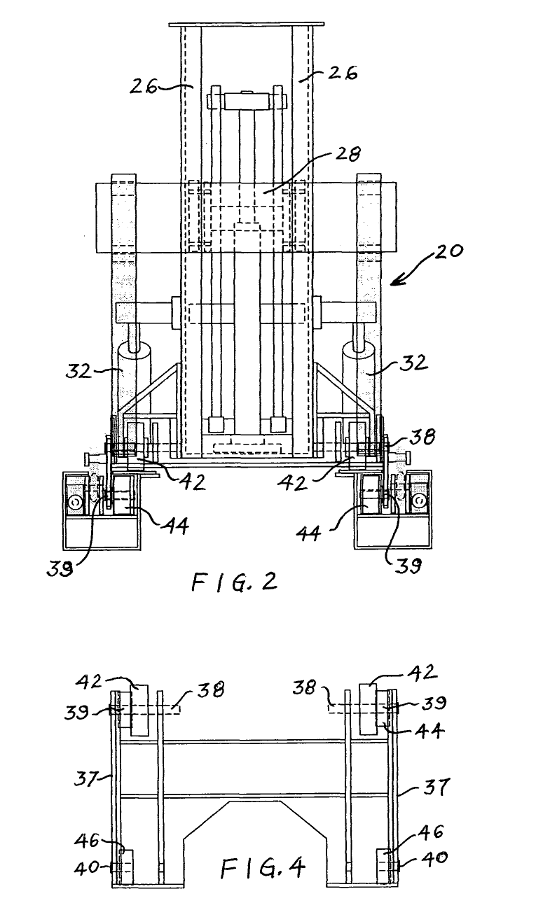

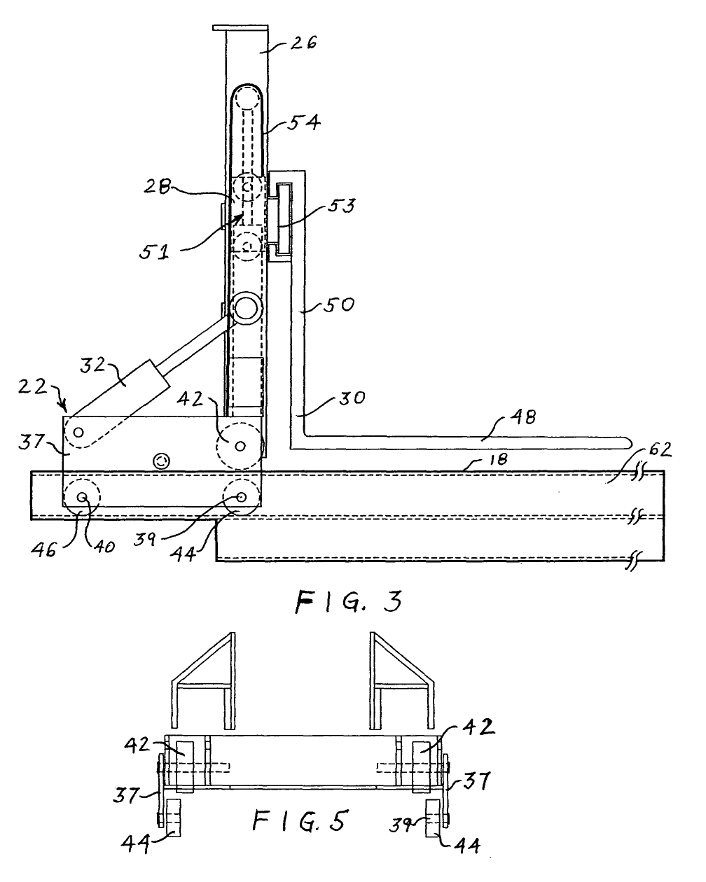

FIG. 3 is a side elevation view of the pallet fork assembly, moveable mast assembly and pallet fork transport.

FIG. 4 is a top plan view with portions removed of the pallet fork transport assembly.

FIG. 5 is a front view of the pallet fork transport assembly.

FIG. 6 is a perspective view with portions removed of the pallet forks and the moveable mast assembly.

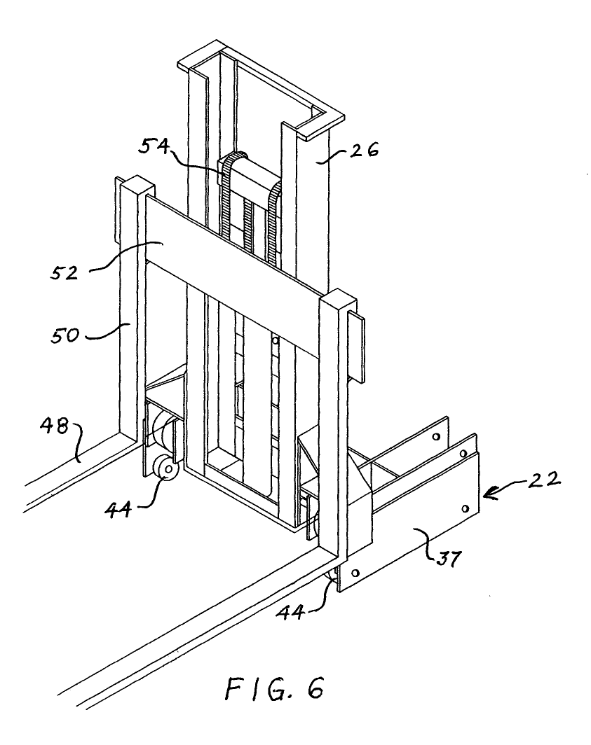

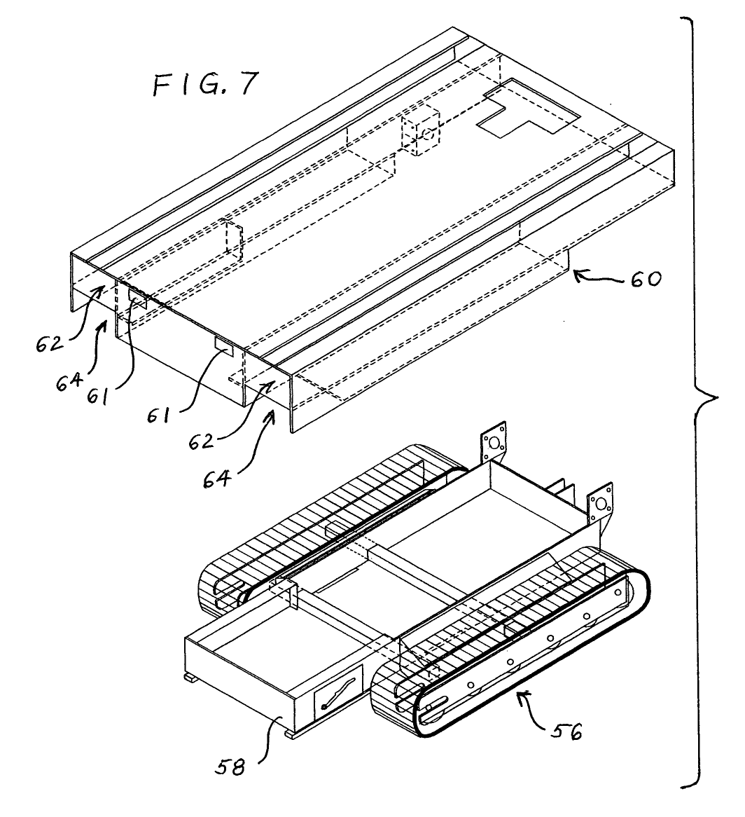

FIG. 7 is an exploded perspective view of the upper and lower frame assemblies.

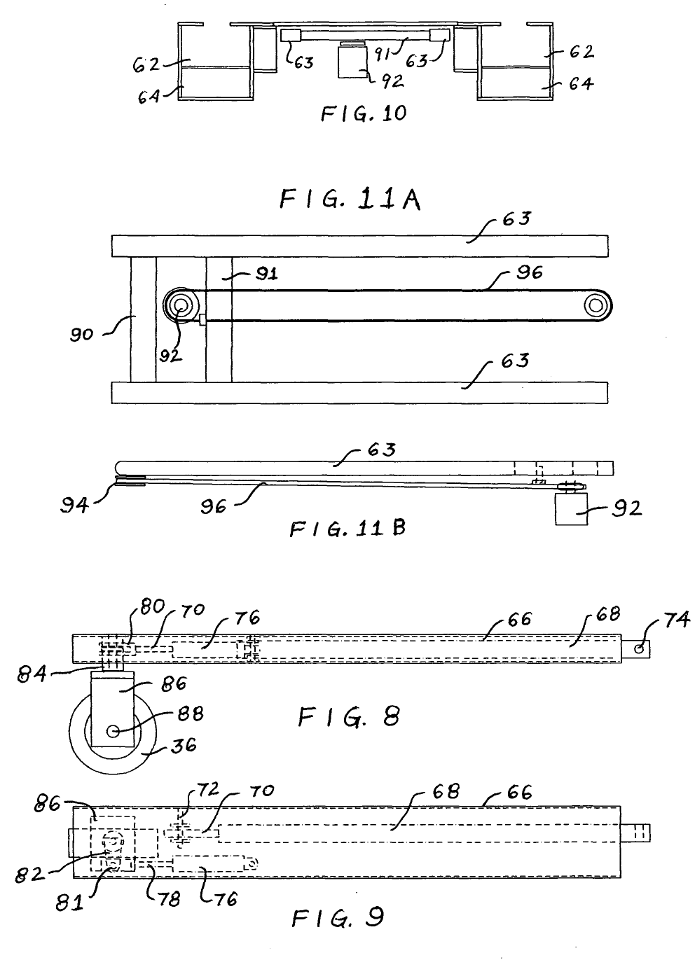

FIG. 8 is a side view of the extendable front wheel assembly.

FIG. 9 is a top plan view of the extendable front wheel assembly and front wheel steering mechanism.

FIG. 10 is a front view of the upper frame assembly and top stabilizer fork assembly.

FIG. 11A is a top plan view of the top stabilizer fork assembly and drive mechanism.

FIG. 111B is a side view of the mechanism of FIG. 11A.

FIG. 12 is a front view of the upper frame and mast movement assembly.

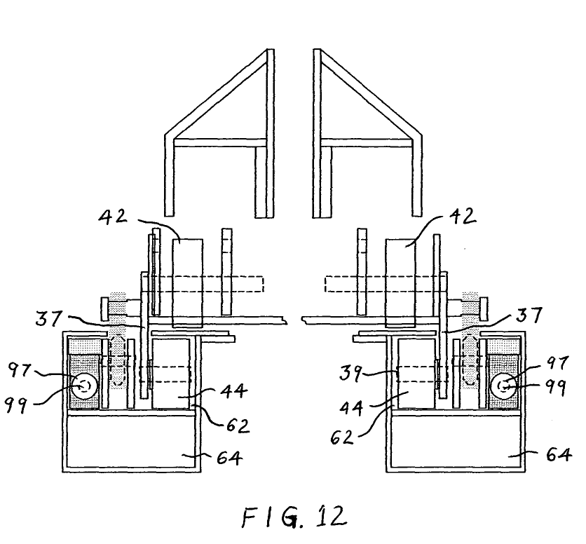

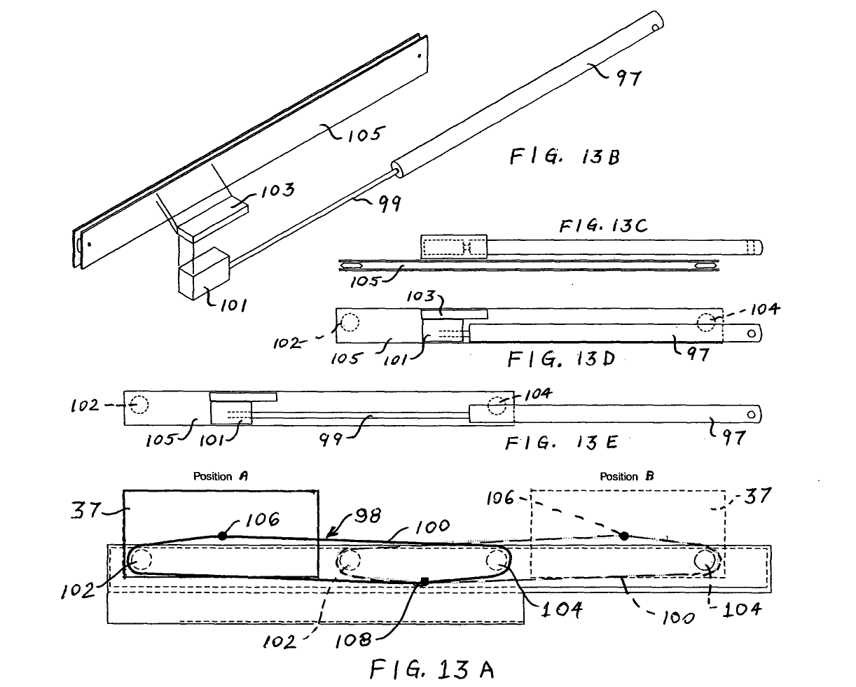

FIG. 13A is a schematic view of the mast and pallet fork transport in the retracted and extended positions.

FIG. 13B is a perspective view of the cylinder drive mechanism used to move the mast assembly to the retracted and extended positions.

FIG. 13C is a top view of the drive mechanism of FIG. 13B.

FIG. 13D is a side view of the drive mechanism of FIG. 13B in the retracted position.

FIG. 13E is a side view of the drive mechanism of FIG. 13B in the extended position.

FIG. 14 is an exploded perspective view of the lower frame assembly and lower stabilizer fork assembly.

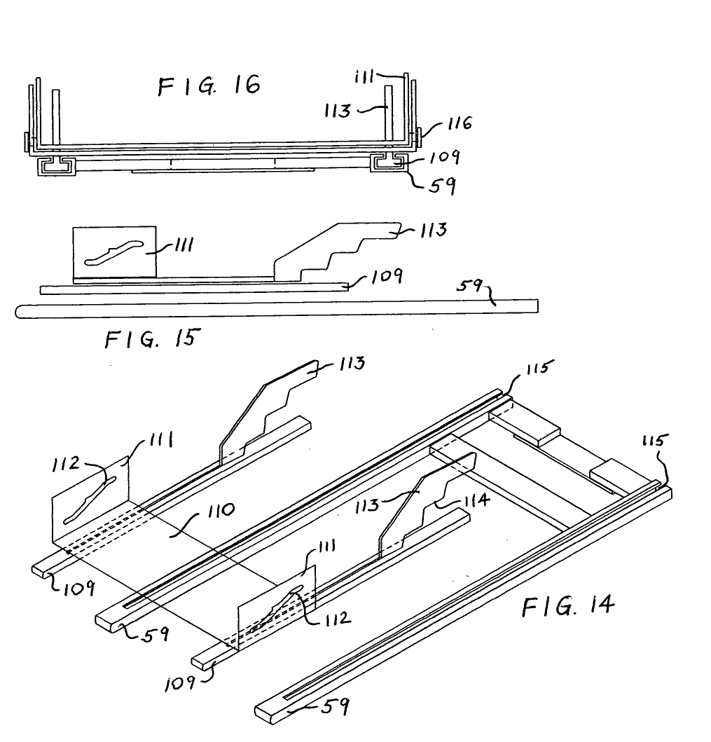

FIG. 15 is a side view of the lower fork stabilizer assembly.

FIG. 16 is an end view of the lower fork stabilizer assembly.

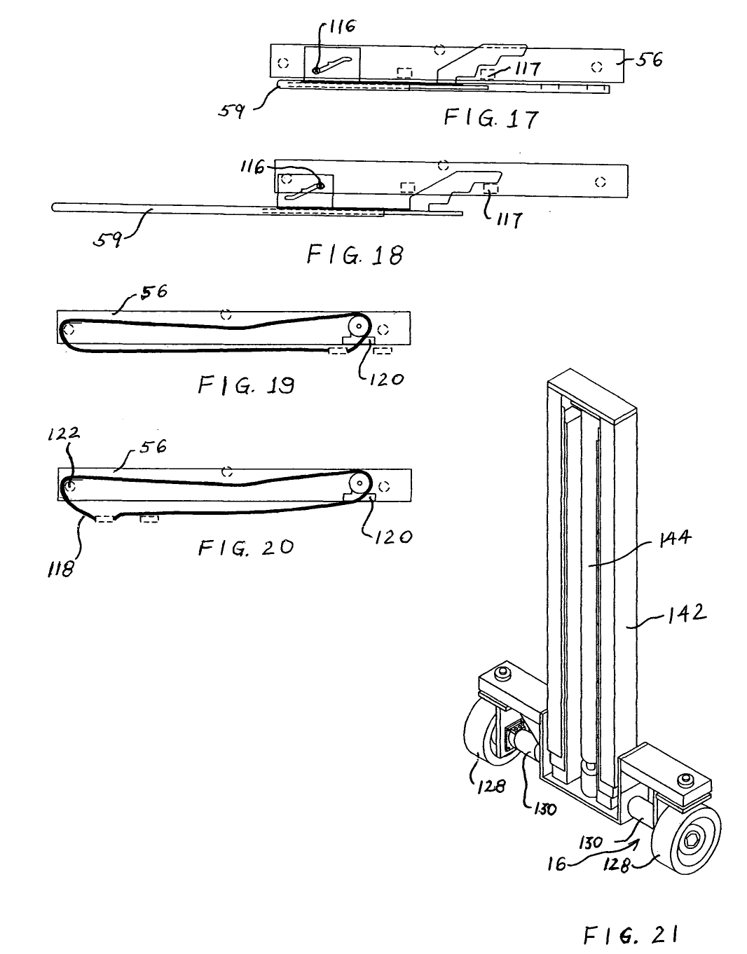

FIG. 17 is a side view of the lower fork stabilizer assembly in the raised position.

FIG. 18 is a side view of the lower fork stabilizer assembly in the lowered position.

FIG. 19 is a side schematic view of the chain drive movement to move the lower fork stabilizer assembly to the raised position.

FIG. 20 is a side schematic view of the chain drive movement to move the lower fork stabilizer assembly to the lowered position.

FIG. 21 is a perspective view of the rear lift drive and steering assembly.

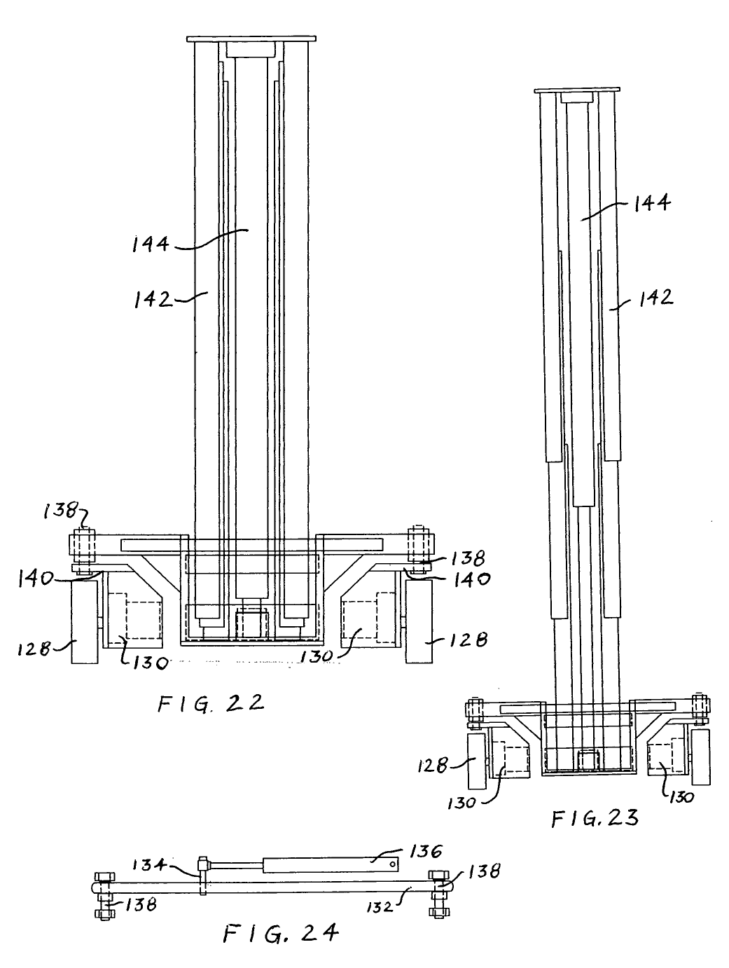

FIG. 22 is a rear view of the rear lift and steering assembly in the lowered position.

FIG. 23 is a rear view of the rear lift and steering assembly in the raised position.

FIG. 24 is a rear view of the rear steering rod and cylinder.

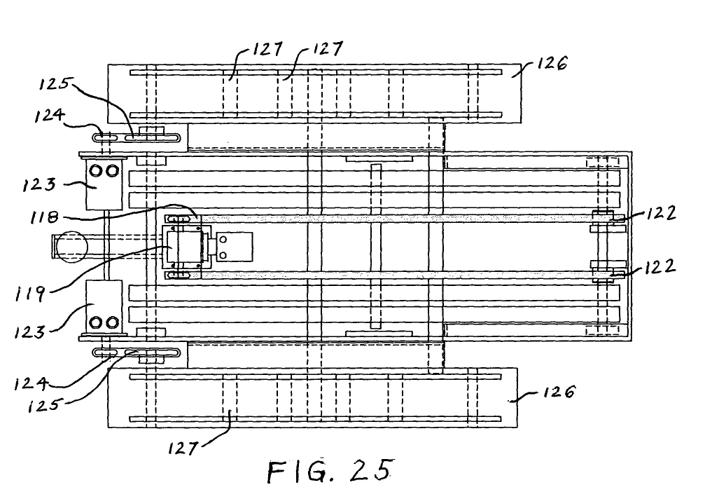

FIG. 25 is a top view of the lower frame, scissors assembly, and endless track drive mechanism.

FIG. 26 is a side view of the scissors member.

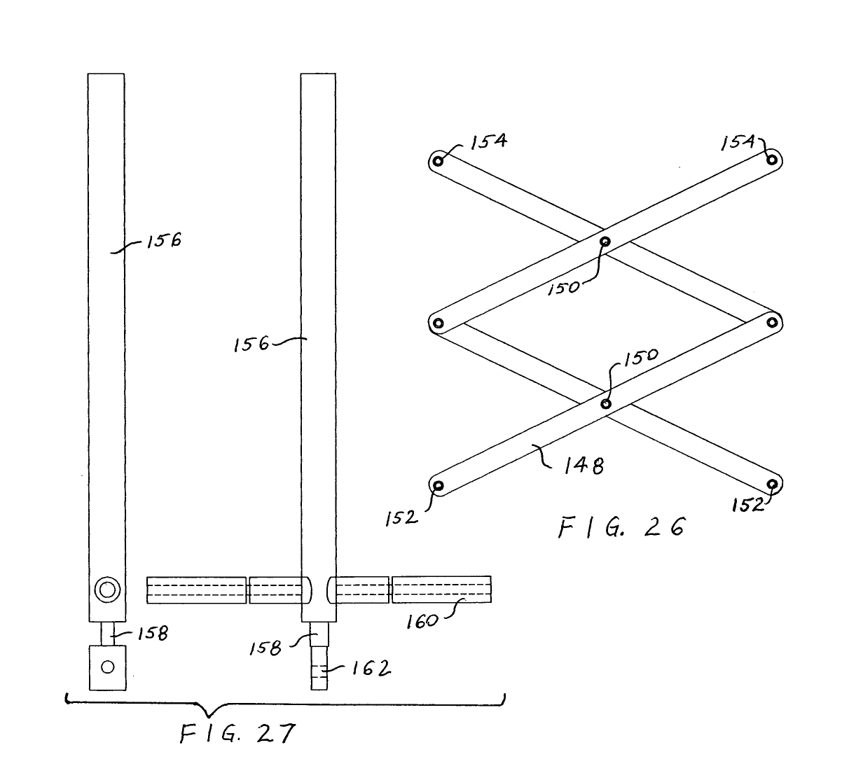

FIG. 27 is a front view of the scissors lift cylinder.

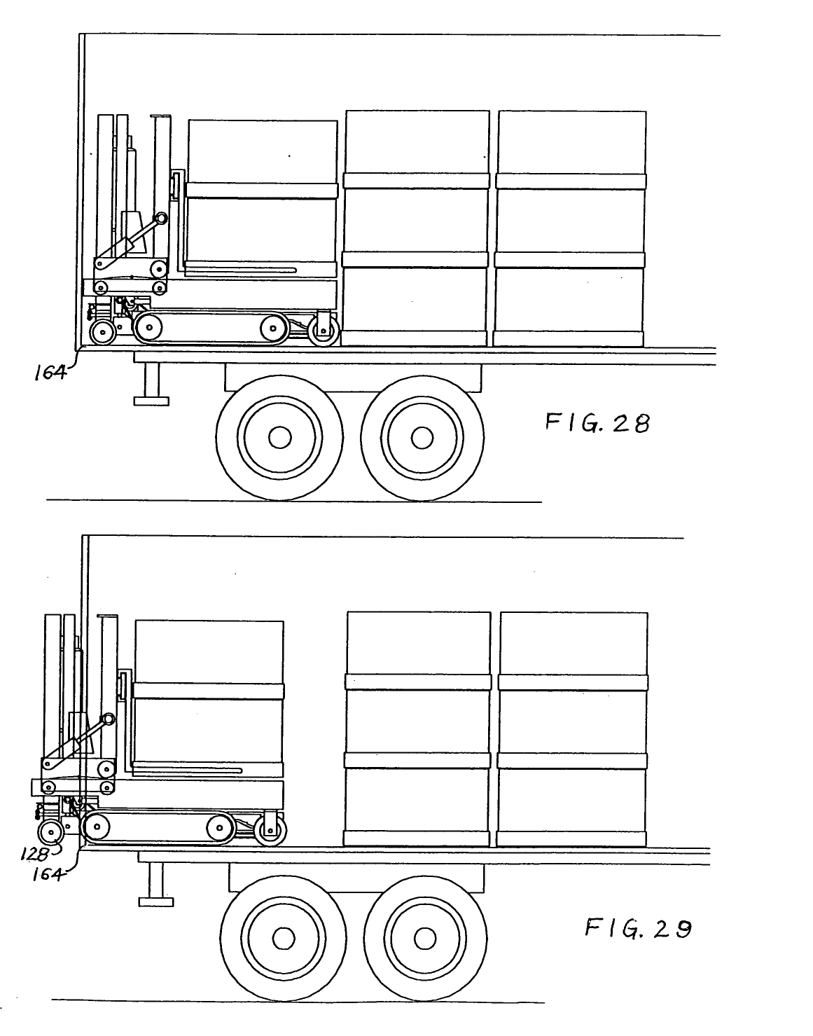

FIG. 28 is a side view of the inventive fork in its stored position loaded onto a truck and ready to remove pallets from the truck.

FIG. 29 is side view of the forklift moved backward with the rear drive wheels extended beyond the trailer.

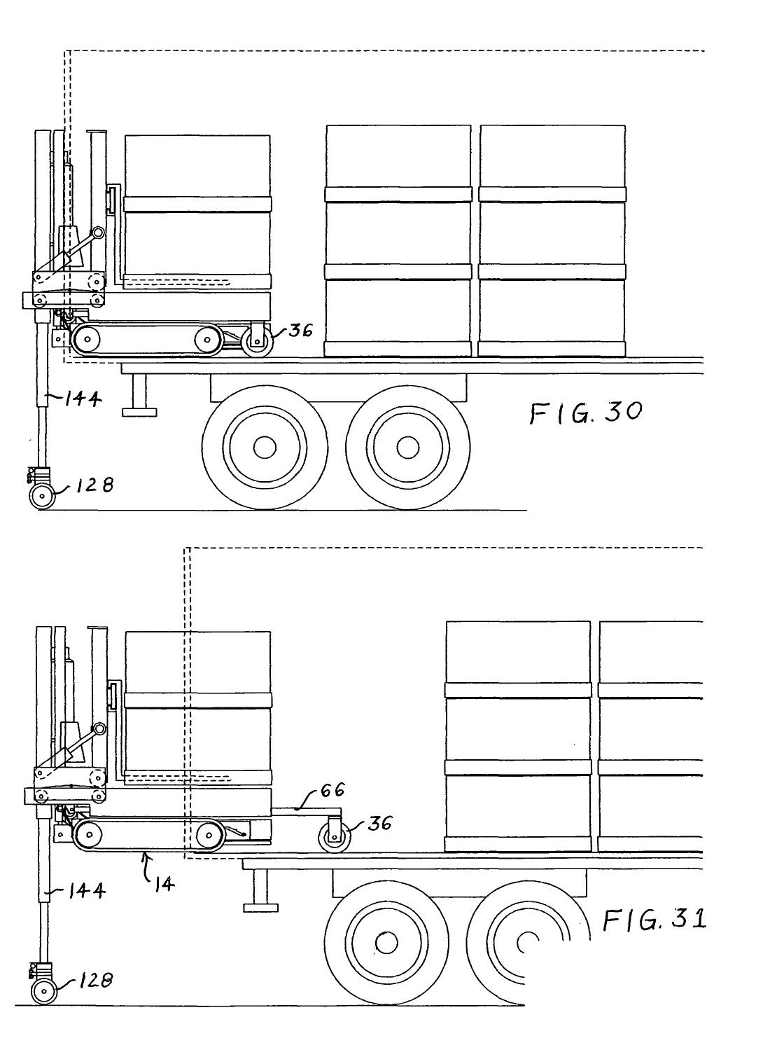

FIG. 30 is a side view of the forklift with the rear wheel extended to the ground.

FIG. 31 is a side view of the forklift with the front wheel extended and the rear wheel drive or the endless track drive moving the forklift away from the truck.

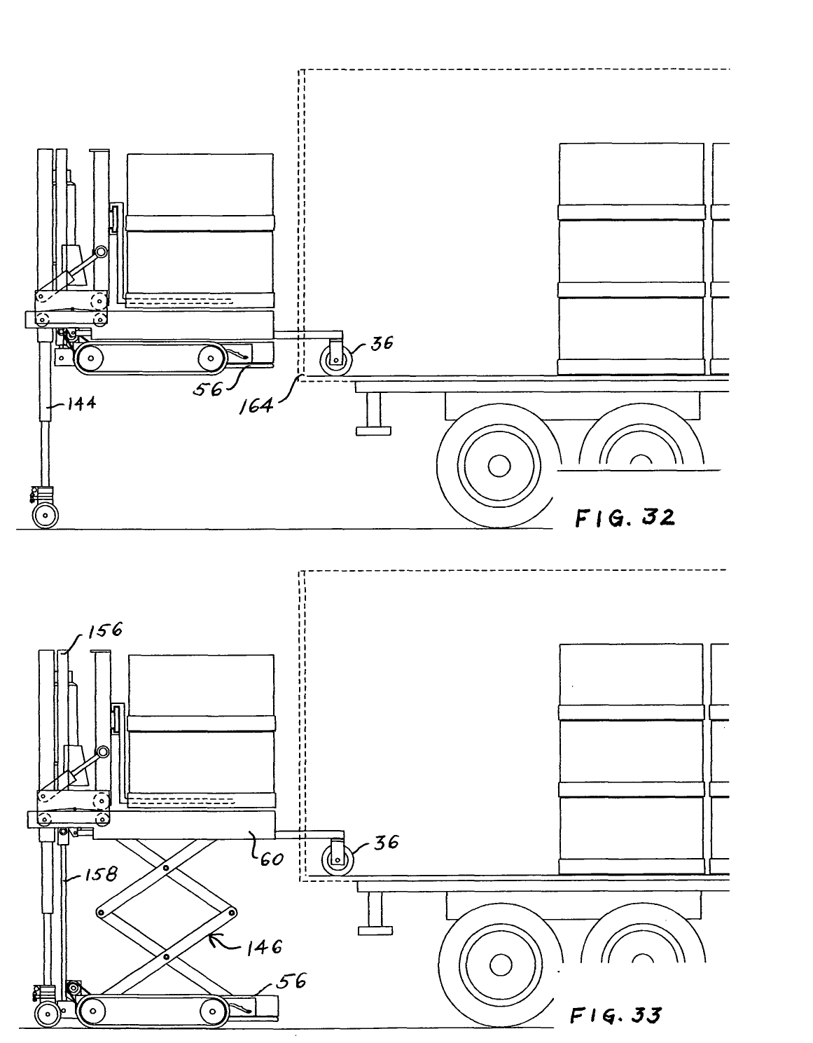

FIG. 32 is a side view of the forklift with the front wheel extended and the load supported by the front and rear wheels.

FIG. 33 is a side view of the forklift with the lower frame lowered to the ground.

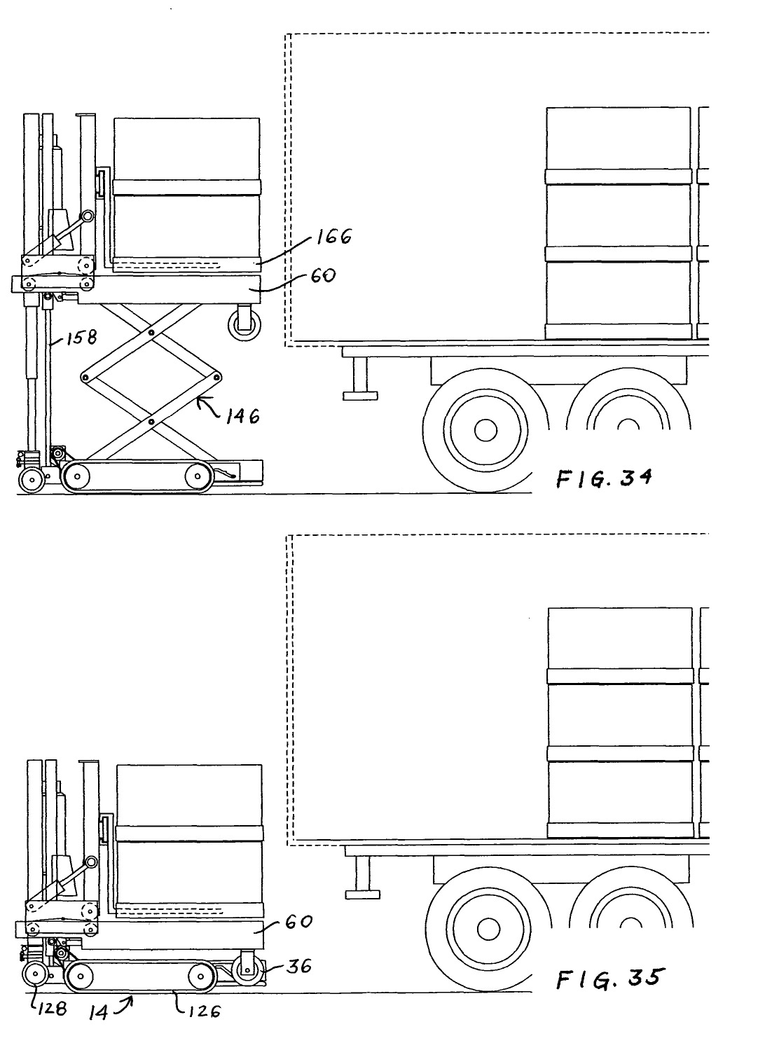

FIG. 34 is a side view of the forklift with the front wheels retracted and the lower frame on the ground.

FIG. 35 is a side view of the forklift with the scissors lift retracted and the rear wheel telescopic frame retracted.

FIG. 36 is a side view of the forklift with the pallet fork lifting a pallet and the lower stabilizer fork extended.

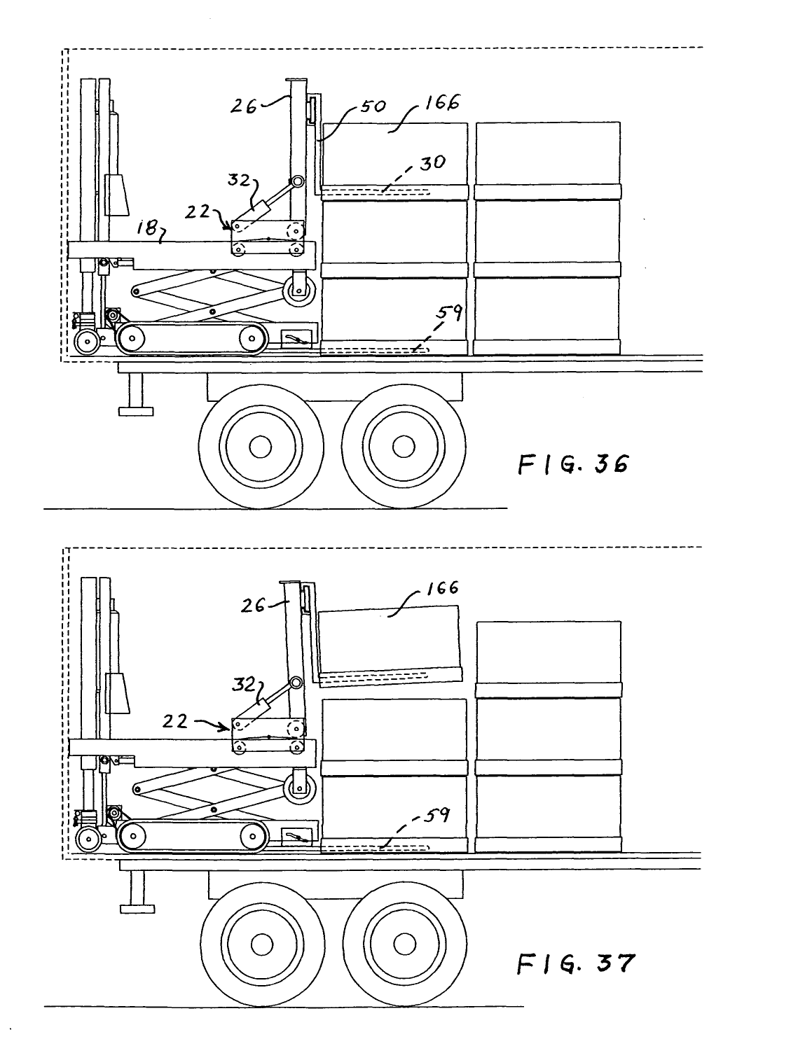

FIG. 37 is a side view of the forklift similar to FIG. 36 with the mast tilted back to remove the top pallet.

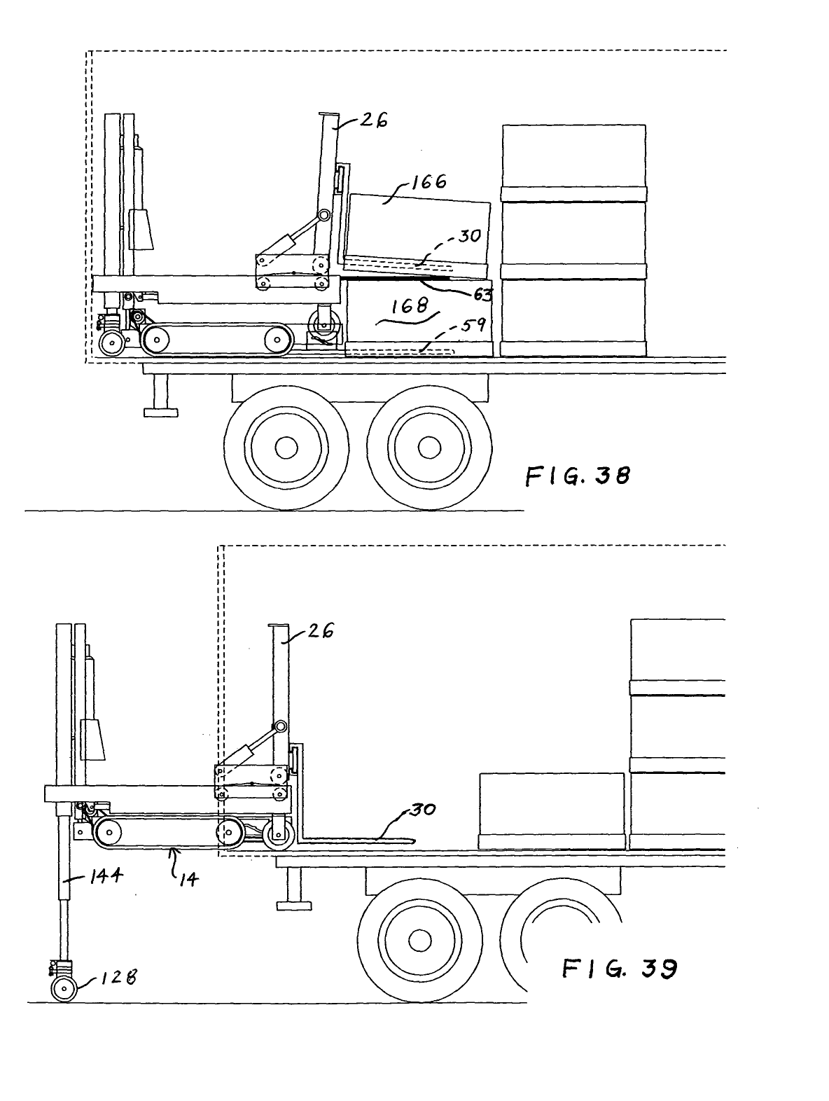

FIG. 38 is a side view of the forklift with the upper stabilizing fork extended and resting on a lower pallet and the lower stabilizing fork extended.

FIG. 39 is a side view of the forklift with the rear wheel lift extended and the front wheel extended on the trailer.

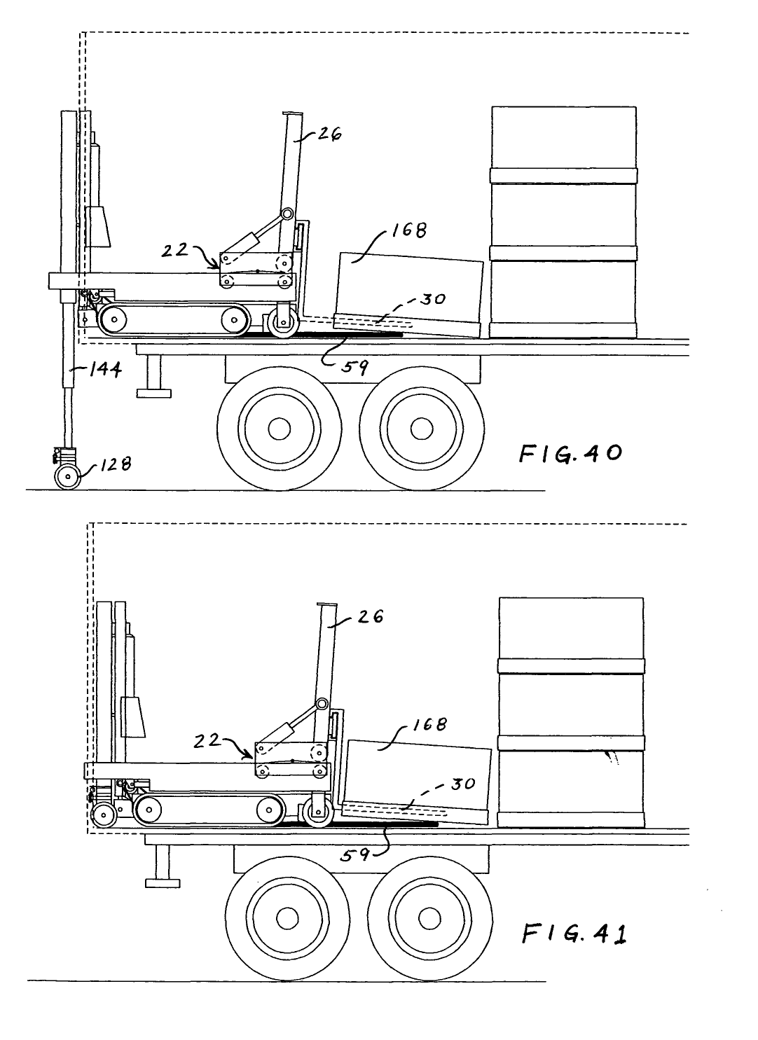

FIG. 40 is a side view of the forklift with the pallet fork lifting the pallet and the lower stabilizer fork extended beneath the pallet.

FIG. 41 is a side view of the forklift with the rear wheel drive retracted and the entire forklift on the trailer with the pallet fork ready to lift the pallet.

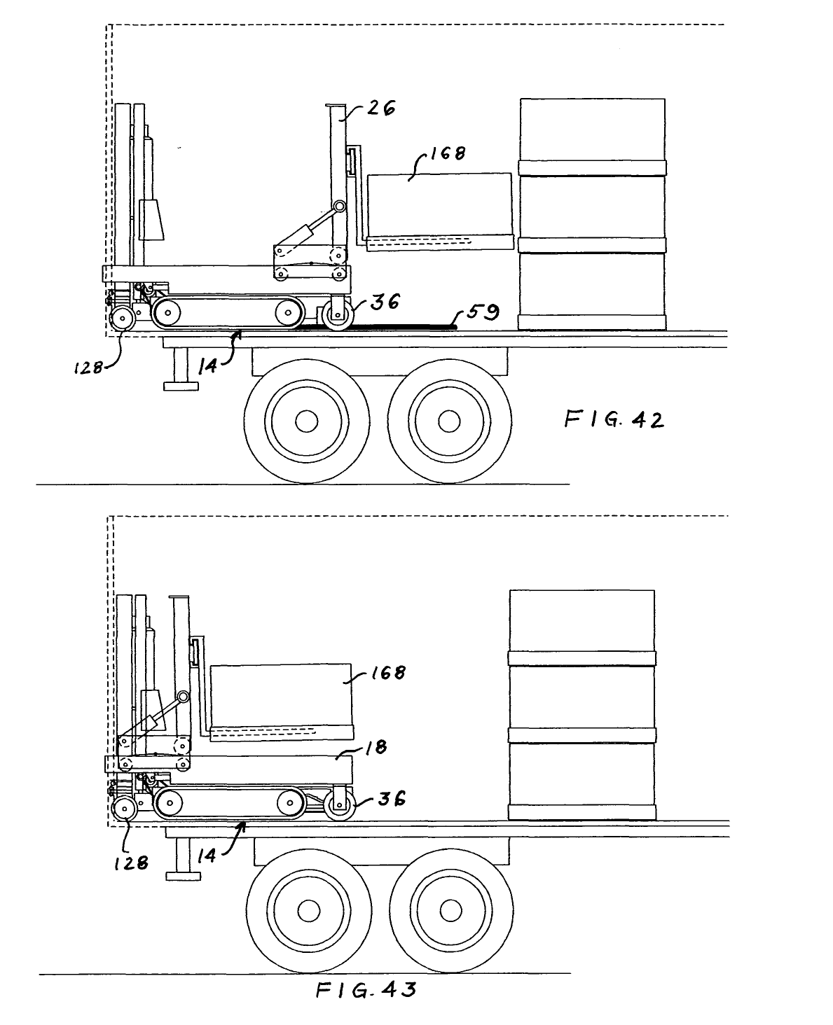

FIG. 42 is a side view of the forklift with the pallet lifted above the deck.

FIG. 43 is a side view of the forklift with the moveable mast retracted and pallet fork above the deck.

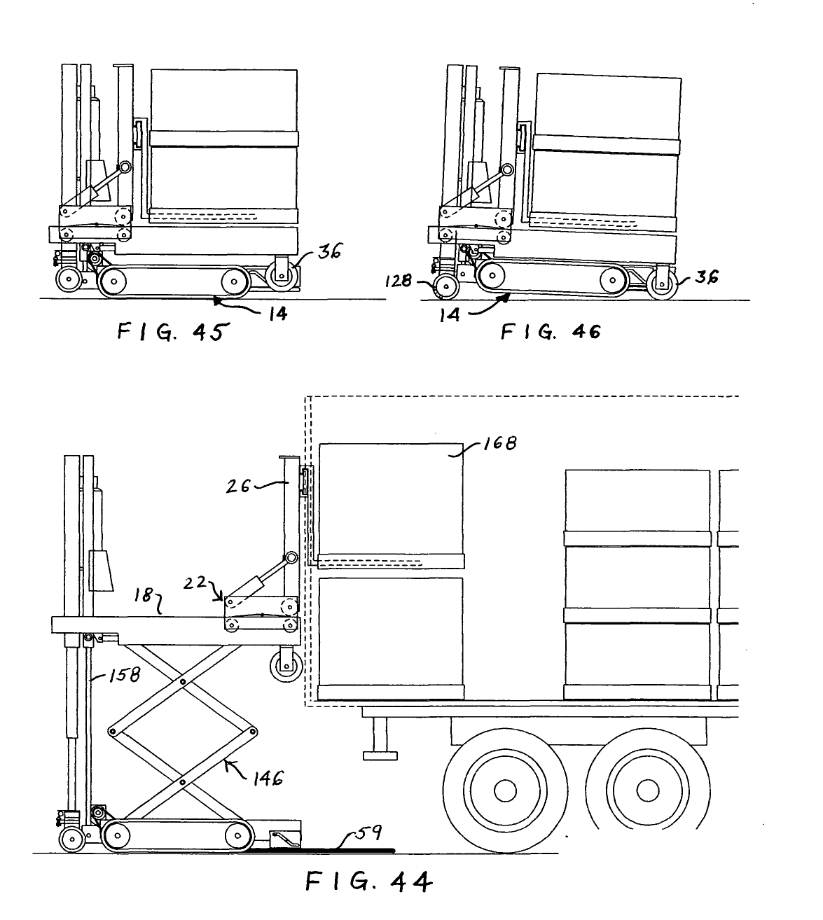

FIG. 44 is a side view of the forklift lifting a load with the scissors lift fully extended and the pallet forks in a raised position.

FIGS. 45 and 46 are two alternative embodiments to move the forklift in a forward or reverse direction using the two drive systems.

### DESCRIPTION OF THE PREFERRED EMBODIMENT

Turning to FIG. 1 there is illustrated a forklift 10 of the present invention. There is a chassis 12 upon which is assembled the forklift 10. The forklift 10 is propelled forward and reverse by a main endless track drive 14 that can move over soft and uneven terrain. There is a rear wheel drive 16 that can also move the forklift 10 forward and rearward. The rear wheel drive 16 is also provided with a steering mechanism to turn the forklift in either a left or right direction. The main endless track drive 14 and rear wheel drive 16 are independently controlled and operated.

A deck 18 is mounted on top of the chassis 12. A pallet fork assembly 20 is mounted on top of the deck 18. The pallet fork assembly 20 is comprised of a moveable mast assembly 22, a mast drive system 24 to move the moveable mast assembly forward and rearward, a mast 26, a pallet fork lift 28, a pallet fork 30 connected to the pallet fork lift 28, and a pallet fork tilt cylinder 32. The pallet fork is lifted and lowered on the mast 26 by the pallet forklift 28. The pallet forks move forward and back on the deck 18 by means of the mast drive system 24 moving the moveable mast assembly 22. A motor 34 provides power to the hydraulic system to operate the forklift 10.

Mounted below the deck 18 is an extendable front wheel 36 that has means to move the extendable front wheel 36 forward of the deck 18. This assists in moving the forklift onto and off of elevated structures as will be described later.

Looking at FIGS. 2-5, the pallet fork assembly 20 and moveable mast assembly 22 are illustrated. FIG. 2 illustrates a front view of the pallet fork assembly 20. The moveable mast assembly 22 moves forward and backwards on top of the deck 18. The top of the deck 18 is positioned between three wheels on each side of the moveable mast assembly 22. Each side has a side plate 37 that supports a plurality of shafts 38, 39 and 40. A main wheel 42 is mounted on the shaft 38 and rides on top of the deck 18. A mast transport front wheel 44 is mounted on shaft 39 below the main wheel 42 and below the top of the deck 18. A mast transport rear wheel 46 is mounted on shaft 40 which is also below the top of the deck 18. The front wheel 44 and rear wheel 46 guide the mast transport along the deck 18 and the main wheel 42 assists in carrying the load.

FIGS. 3 and 6 illustrate the mechanism used to raise and lower the pallet forks 30. The pallet forks 30 are generally L-shaped with a horizontal arm 48 designed to be placed under the load, and a vertical arm 50, which is connected to a lifting mechanism 51. As illustrated, the vertical arms 50 are mounted to a cross bar 52. The cross bar 52 in turn is mounted to a t-bar 53 which is operatively connected to a chain drive 54 in the mast 26 that raises or lowers the lifting mechanism 51 which in turn raises or lowers the cross bar 52. Instead of a chain drive, other hydraulic drives can be utilized as is known in the art. The pallet forks 30 are mounted to the mast 26, which in turn is mounted to the moveable mast assembly 22.

As seen in FIG. 7, the main drive 14 is mounted on a lower frame assembly 56. There is a lower frame 58 on which is mounted the main endless drive track 14. There is a pair of lower stabilizing forks 59 (FIG. 1) mounted to the bottom of the lower frame 58, which are adapted for forward and rearward movement. Mounted above the lower frame assembly 56 is an upper frame assembly 60. The deck 18 is on the top surface of the upper frame assembly 60. Extending along the length of the upper frame assembly, from the front to the rear and along both sides are mast transport wheel channels 62 that receive the mast transport wheels 44, 46. On the underside of the deck 18 are a pair of top stabilizer fork channels 61 that receive a pair of top stabilizer forks 63. The top stabilizer forks are adapted for forward and rearward movement in the fork channels 61 as will be described later. There is also a front wheel frame channel 64 that receives the extendable front wheel 36.

FIGS. 8 and 9 illustrate how the movement of the extendable front wheel 36 is controlled. There is a moveable frame 66 received within the front wheel frame channel 64. The frame 66 can slide within the channel 64. Inside of the moveable frame 66 is a cylinder 68 that has a piston 70 extending out from the front of the cylinder 68. The end of the piston 70 is connected to a rod 72, which is in turn connected to the inside of the moveable frame 66. The end of the cylinder opposite the piston 70 is attached to the chassis 12 by means of mounting hole 74. When the piston 70 extends forward, the moveable frame 66 extends forward out of the front wheel frame channel 64. When the piston 70 withdraws into the cylinder 68, the moveable frame 66 is drawn back into the front wheel frame channel 64.

The direction of the front wheel 36 is controlled by a steering mechanism. A steering cylinder 76 has its rear end connected to the inside of the moveable frame 66. A steering piston 78, protruding from the front end, is connected to a yoke 80. The yoke 80 has shaft 81 connecting it to link 82. The other end of the link 82 is connected to a steering linkage 84, which in turn is connected to a front wheel support frame 86. The front wheel 36 is mounted on a shaft 88 that is retained in the front wheel support frame 86. When the piston 78 moves forward and backward, the link 82 pivots, turning the linkage 84, which in turn controls the direction of the front wheel 36.

The operation of the top stabilizer forks 63 is illustrated in FIGS. 10, 11A and 11B. One of the top stabilizer forks 63 is placed in each of the top stabilizer fork channels 61. The top stabilizer forks 63 are connected together by cross arms 90, 91. A motor 92 is mounted to the upper frame assembly 60. Mounted at the front of the forklift 10 is a chain pulley 94. A chain 96 is wrapped around the chain pulley 94 and motor 92 so that when the motor 92 is operated, the chain 96 moves in either the forward or reverse direction. As the chain 96 is attached to the cross arm 91., the top stabilizer forks 63 move with the chain 96. Thus the top stabilizer forks 63 can be selectively moved forward of the forklift 10 or retracted back under the deck 18 and into the fork channels 61.

FIGS. 12 and 13A-E illustrate the movement of the moveable mast assembly 22. Position A illustrates the moveable mast assembly 22 in the front or most forward position. To move the mast forward so that the pallet forks 30 move forward under a load, a chain drive 98 is used. A hydraulic cylinder 97 has one end attached to the upper frame assembly 60. A cylinder rod 99 exiting the cylinder 97 is attached to block 101 which is in turn attached to mounting bracket 103. The mounting bracket 103 is connected to sliding bracket 105 with sprockets 102 and 104 at either end. A chain 100 is mounted around the sprockets 102, 104. The chain 100 is attached to the side plate 37 at attachment point 106. The chain 100 is also attached to the upper frame assembly 60 at attachment point 108. Power is applied to the chain 100 by means of hydraulic cylinder 97. Because the chain 100 is attached to the upper frame 60 at point 108, the side plate is pulled forward to the position shown as Position B. By reversing the direction of movement of the chain 100, the side plate 37 moves back to Position A, or any position between positions A and B as desired. A control system controls energizing the hydraulic cylinder 97 in the forward or reverse direction as known in the art to control the amount and direction of movement of the slide plate 37 and the moveable mast assembly 22.

Using this system allows the mast to move four feet on the deck while the rod 99 moves two feet. An alternative system is to use a motor with a right angle speed reducer mounted at the rear of the forklift 10 mounted on top of the deck 18.

The operation of the lower stabilizing forks 59 is illustrated in FIGS. 14 through 18. As the lower stabilizing forks 59 are used to stabilize the forklift 10, they must first be place in contact with the ground or surface on which they are to rest and stabilize the forklift 10. This means that the lower forks 59 must first be lowered from the position illustrated in FIG. 1 to a position in which the forks 59 contact the ground or trailer as illustrated in FIG. 36. As seen in FIG. 14 there is a pair of rails 109 connected together by a cross brace 110. There are upstanding sidepieces 111 at the front of the rails 109. Each sidepiece has an angulated slot 112 cut into the sidepiece 111. Towards the back of the rail 109 is an upstanding stepped piece 113 having a series of steps 114. There is a channel 115 in each of the lower stabilizing forks 59, which receive the rails 109 in sliding relationship. FIG. 15 illustrates the rails 109 positioned above the lower stabilizing forks 59, before being inserted into the forks 59. FIG. 16 is a front view of the rails 109 inside of the stabilizing forks 59.

As seen in FIGS. 17 and 18, there is a pin 116 extending inward from the lower frame 56 that fits into angulated slot 112. The stepped piece 113 has one of its steps 114 resting on a block 117 also extending inward from the frame 56. By moving the rails 109 forward or backward (to the left or right respectively as seen in FIGS. 17 and 18), the lower stabilizing forks 59 are lowered or raised respectively with respect to the ground surface.

The forward and rearward movement of the lower stabilizing forks is controlled by a chain drive as seen in FIGS. 19, 20 and 25. FIG. 19 corresponds to the position of the lower stabilizer fork 59 as seen in FIG. 17 and FIG. 20 corresponds to the position of the lower stabilizer fork as seen in FIG. 18. A chain 118 is connected to the lower forks 59 and driven by a lower fork motor 120. The motor 120 drives the chain 118 in either direction to move the lower stabilizing forks 59 forward or backward. The chain 118 is wrapped around a drive gear in the motor 119 and a sprocket 122 at the forward end of the lower frame 56. Other methods of moving the forks 59 are apparent to those skilled in the art.

The forklift 10 is moved forward and rearward by the main drive 14 and the rear wheel drive assembly 16. The rear wheel drive assembly 16 is illustrated in FIGS. 21-24. There is a pair of rear wheels 128 on either side of the forklift 10. The rear wheels 128 are connected to and driven in either a forward or rearward direction by motors 130. These can be either hydraulically operated motors or electric motors. A control system (not illustrated) controls the direction and speed of the motors 130. The rear wheel drive assembly is operated separately of the main drive 14 so that only one of the drives is operating at a time.

The main drive 14 is illustrated in FIGS. 1 and 25. The main drive is preferably an endless track so that the forklift 10 can move over uneven terrain. There is a pair of main drive motors 123, each connected by a chain or pulley drive 124 to a drive sprocket 125. This drives an endless track 126 that is supported by a series of wheels 127. The drive motors 123 are operated independently so that either endless track 126 can be driven in either direction. This allows the forklift 10 to make 90° turns and maneuver in tight places. Various alternatives of endless track designs are known to those skilled in the art.

The rear wheel drive assembly has a steering assembly illustrated in FIG. 24. There is a steering rod 132 connected by means of linkage 134 to a steering cylinder 136. The opposite ends of the steering rod 132 are connected by pins 138 to a steering frame 140. The steering frame 140 is connected to the rear wheels 128 so that the left or right direction of the wheels 128 is controlled. When the cylinder 126 is operated, the amount and direction of movement of the steering rod 132 is controlled which controls the direction of the wheels 128.

Another unique aspect of the forklift 10 is that it has a rear telescoping frame 142. FIG. 22 shows the frame 142 in the lowered position and FIG. 23 shows the frame 142 in the raised or extended position. A rear hydraulic cylinder 144 raises and lowers the telescoping frame 142. When the telescoping frame 142 is raised, the entire forklift 10, with the exception of the rear wheel drive assembly, is raised above the ground, as will later be described in greater detail.

Another unique aspect of the forklift 10 is the ability to move the upper frame assembly 60 vertically with respect to the lower frame 56. This is accomplished by means of a scissors lift assembly 146. As seen in FIG. 33 the scissors lift assembly 146 is in the raised position with the upper frame assembly 60 raised from the lower frame 56. There is a plurality of scissors members 148 (FIG. 26) joined at pivot points 150. Lower ends 152 are attached to the lower frame 56 and upper ends 154 are attached to the upper frame assembly 60. A pneumatic or hydraulic scissors cylinder 156 operates a piston 158, which provides the force to raise to raise and lower the upper frame assembly 60. The scissors cylinder 156 is mounted at the rear of the forklift 10 as seen in FIG. 1. Support arms 160 (FIG. 27) extending from either side of the cylinder 156 secure the cylinder 160 in an upright position while securely attaching the cylinder 156 to the chassis 12. A bottom portion 162 of the scissors piston 158 is secured to the lower frame 56. Using a conventional controller (not illustrated) the movement of the piston in the scissors cylinder 156 is controlled thus selectively raising and lowering the upper frame assembly 60.

It is contemplated that a remote control controller will operate all of the control systems. The main drive motors, rear wheel drive motors, steering cylinders, scissors cylinder, and all fork movements can be controlled by means of remote control. In this manner, the entire forklift is controlled without an operator actually sitting on the forklift 10. Thus the operator can stand near the forklift, control all movements, and yet be safe in the event that the forklift falls or tips over. A further advantage is that this enables the forklift to be smaller than a conventional forklift, which requires the operator to sit on the device. Thus the forklift can be stored on a truck and transported with the loads as seen in FIG. 28. Palletized loads completely fill the truck and the forklift 10 holds one or two additional pallets, thus maximizing the capacity of the transport truck.

When the transport truck reaches the destination, the tailgate is opened and the main drive 14 is put in reverse. The forklift backs up until the rear wheel drive 16 and rear wheel 128 extend beyond an end portion 164 of the trailer as seen in FIG. 29. The main drive is then stopped. The rear hydraulic cylinder 144 is activated so that it extends downward until the rear wheel 128 strikes the ground (FIG. 30). The rear telescoping frame 142 also telescopes downward as seen in FIG. 23, although not illustrated in FIG. 30. The forklift 10 is now mainly supported by the rear wheel 128 and its supporting structure and the extendable front wheel 36. Some weight may still be supported by the main drive 14, but it is intended that most of the weight of the forklift 10 will no longer be on the endless track 126.

The rear wheel drive motors 130 are energized to drive the rear wheels 128 in the reverse direction. Simultaneously, energizing the cylinder 68 to move forward the moveable frame 66 extends the extendable front wheel 36 forward (FIG. 31). The rear wheels 128 continue moving backward until the main drive 14 and upper frame assembly 60 clear the end portion 164 of the trailer (FIG. 32). The rear wheels 128 and front wheels 36 support the forklift 10 and the load it's carrying. The lower frame assembly 56 is then lowered to the ground by actuating the scissors cylinder 156, which extends the piston 158. The lower assembly 56 continues downward lifting the extendable front wheels from the floor of the trailer (FIG. 33).

The extendable front wheel 36 is retracted so that the load on pallets 166 clears the end portion 164 of the trailer (FIG. 34). The scissors lift assembly 146 is actuated to lower the upper frame assembly 60 so that the front wheel 36 is slightly above the ground. The rear wheels 128 are raised from the ground. All weight of the forklift 10 and the load is now on the endless track 126 of the main drive 14 (FIG. 35). The forklift is ready to move across most terrain that will be encountered by the forklift 10.

Another unloading situation is illustrated in FIGS. 36-37. The forklift is again on the trailer. In this situation it is desired to lift a top pallet 166 from a stack of pallets. The lower stabilizing forks 59 are extended forward and rest on the floor of the lowermost pallet or on the trailer floor. The moveable mast assembly 22 is moved forward along the deck 18 toward the front of the forklift 10. The pallet forks 30 are inserted into the base of the top pallet 166 (FIG. 36). The pallet fork tilt cylinder is activated to tilt the mast 26 back to remove the top pallet 166 from the remaining stack of pallets (FIG. 37). The moveable mast assembly 22 is then moved back towards the back of the forklift 10 so that the pallet 166 is positioned over the main drive 14. The lower stabilizing forks 59 are withdrawn into the lower frame assembly 56 and the forklift is removed from the trailer as previously described.

FIG. 38 illustrates another situation where both the lower stabilizing forks 59 and the top stabilizer fork 63 are extended. The pallet forks 30 are inserted into the top pallet 166. The upper stabilizing forks 63 extend into and rest on an upper surface of load 168. The lower stabilizing forks 59 rest on the trailer floor. The mast 26 is tilted forward to raise the pallet 166 from the load 168.

FIG. 39 illustrates the forklift 10 with the rear hydraulic cylinder 144 extended and the rear wheel 128 on the ground. The moveable mast assembly 22 is in the forward position and the pallet fork assembly 20 with the pallet forks 30 in their lowermost position. The deck 18 is in its lower position with the extendable front wheel 36 on the trailer floor. This allows the pallet forks 30 to be at the floor level on the trailer to enter the lowermost pallet.

FIG. 40 illustrates the forklift 10 with the pallet forks 30 entering the base of the pallet 168. Upon forward movement of the rear wheel drive 16 or main drive 14, the pallet 168 is raised which allows the lower stabilizing forks 59 to slide under the pallet 168. Depending upon how far forward the pallet 168 is located, the rear wheel 128 may have to be raised above the trailer bed. Then the main drive 14 is activated to move the forklift 10 onto the trailer and push the pallet forks 30 completely into the pallet. The stabilizing forks 59 remain extended to stabilize the forklift 10 as the mast tilts backward to raise the pallet 168 (FIGS. 41 and 42). The moveable mast assembly 22 is moved backward with the pallet 168 supported by the pallet forks 30. The pallet 168 is then centered over the deck 18 and the lower stabilizer forks 59 are retracted (FIG. 43). The pallet 168 can be lowered onto the deck 18 if desired.

FIG. 44 illustrates the versatility of the forklift 10 to raise and retrieve loads that are up to approximately 68 inches in height. The moveable mast 22 is moved to its extreme forward position. The scissors lift assembly 146 is raised to its maximum height. Likewise the rear telescoping frame 142 is also extended to its fullest height. The pallet forks 30 are raised to their maximum height along the mast 26. The stabilizing forks 59 are extended forward for stability allowing the pallet 168 to be raised and removed from the trailer. The moveable mast 22 is moved back so that the pallet 168 is positioned above the deck 18. The stabilizing forks 59 are retracted and the scissors lift assembly 146 may or may not be lowered as desired. The main drive 14 or rear wheel drive 16 moves the pallet 168 to the desired location.

FIG. 45 illustrates the forklift 10 with the rear wheels 128 and front wheels 36 raised above the main drive 14 so that the main drive 14 moves the forklift 10. This is the position that permits the forklift to move over varying terrain. When the forklift reaches a location that has smooth floors, such as inside of a store or warehouse, the rear telescoping frame is extended so that the rear wheels 128 engage the floor. The main drive and endless track 126 are raised off of the ground and the rear wheels 128 and front wheels 36 support the weight of the forklift 10. This avoids marking the floor with the endless track.

With the numerous adjustable systems on the forklift 10, it is apparent that many various configurations and movements of the forklift are possible. The above examples are illustrative of several configurations and methods to move loads from a trailer. By reversing the steps, the loads can be placed onto the trailer. The stabilizer forks 59 enable the forklift to place and retrieve loads that were previously not capable of maneuvering with a forklift of this size.

Thus there has been provided a forklift for moving loads between two different levels that fully satisfies the objects and advantages set forth above. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A forklift for moving between two substantially horizontal surfaces including a higher horizontal surface at a first level and a lower horizontal surface at a second level comprising:
a chassis with a front and rear end;
a horizontal drive system attached to the chassis for moving the forklift truck horizontally;
a deck having a forward end and a rearward end mounted to the chassis;
a vertical mast mounted on the deck;
drive means for moving the vertical mast forward and rearward on the deck;
a pallet fork assembly attached to the vertical mast and means for moving the pallet fork assembly up and down on the vertical mast for raising and lowering loads placed on the pallet fork assembly;
deck lifting means for raising the deck;
a front wheel frame slidably mounted beneath the deck for forward movement of the front wheel frame to an extended position forward of the deck;
a front wheel mounted to the front wheel frame;
at least two upper stabilizing forks, one disposed on either side of the forklift, the upper stabilizing forks mounted for forward and rearward movement, and
a lower stabilizing fork mounted to the chassis and disposed below the upper stabilizing forks and adapted for forward and rearward movement and further mounted for movement from the chassis to the lower horizontal surface.

2. The forklift of claim 1 wherein the deck lifting means comprises a scissors lift mounted to the chassis and below the deck.

3. The forklift of claim 1 wherein the deck lifting means comprises telescopic lifting means having two ends, one end connected to the deck and the other end connected to the chassis.

4. The forklift of claim 1 and further comprising a front wheel channel disposed beneath the deck for slidably receiving the front wheel.

5. The forklift of claim 1 and further comprising a second horizontal drive system attached to the chassis for moving the forklift horizontally forward and backward.

6. The forklift of claim 5 and further comprising a motor driving the at least one wheel mounted at the rear end of the chassis.

7. The forklift of claim 1 and further comprising steering means operatively connected to the horizontal drive system for controlling the direction of the forklift as it moves horizontally.

8. The forklift of claim 1 and further comprising third extending drive means for moving the front wheel frame to the extended and stored positions.

9. The forklift of claim 1 wherein the front wheel frame is connected to the deck and is raised and lowered in unison with the deck by means of the lifting means.

10. The forklift of claim 1 and further comprising a remote control controller for remotely controlling the horizontal drive system, drive means for moving the vertical mast, means for moving the pallet fork assembly, deck lifting means, upper stabilizing forks and lower stabilizing forks.

11. A forklift for moving between two horizontal surfaces at first and second levels comprising:
a chassis having a front end and a rear end;
a forward mounted drive system attached to the chassis for moving the forklift horizontally forward and backward;
a rearward mounted drive system attached to the chassis for moving the forklift horizontally forward and backward;
control means for independently operating the forward mounted drive system and rearward mounted drive system;
a deck mounted to the chassis, the deck having a forward and a rearward end;
a pallet fork assembly mounted on the deck;
pallet fork drive means for moving the pallet fork assembly in a forward and rearward direction on the horizontal deck;
a pallet fork mounted on the pallet fork assembly;
pallet fork lifting means connected to the pallet fork for raising and lowering the pallet fork;
deck lifting means for raising and lowering the deck;
a front wheel frame slidably mounted for forward and rearward movement from a stored position to an extended position forward of the forward end of the horizontal deck and back to the stored position;
a front wheel mounted to the front wheel frame;
upper stabilizing forks mounted to the chassis;
first extending drive means for extending and retracting the upper stabilizing forks;
a lower stabilizing fork mounted to the chassis below the upper stabilizing forks and adapted for resting upon the horizontal surface; and
second extending drive means for extending and retracting the lower stabilizing forks.

12. The forklift of claim 11 wherein the forward mounted drive system comprises a motor driving an endless track encircling a plurality of wheels.

13. The forklift of claim 11 and further comprising steering means operatively connected to the forward mounted drive system for controlling the direction of the forklift as it moves horizontally.

14. The forklift of claim 11 wherein the pallet fork assembly further comprises a vertical mast mounted on the deck, and the pallet fork is connected to the vertical mast for vertical movement thereon.

15. The forklift of claim 14 and further comprising pallet fork lifting means operatively connected to the pallet fork for raising and lowering the pallet fork along the vertical mast.

16. The forklift of claim 11 wherein the deck lifting means for raising and lowering the deck comprises a scissors lift mounted below the deck.

17. The forklift of claim 11 wherein the deck lifting means for raising and lowering the deck comprises telescopic lifting means mounted above the rearward mounted drive system, the telescopic lifting means having one end connected to the deck and another end connected to the chassis.

18. The forklift of claim 11 and further comprising third extending drive means for moving the front wheel frame to the extended and stored positions.

19. The forklift of claim 11 wherein the front wheel frame is connected to the deck and is raised and lowered in unison with the deck by means of the deck lifting means.

20. The forklift of claim 12 wherein the rearward mounted drive system comprises a motor driving at least one wheel mounted at the rear of the chassis.

21. The forklift of claim 11 and further comprising a remote control controller for remotely controlling the forward mounted drive system, pallet fork drive means, pallet fork lifting means, deck lifting means, front wheel frame, upper stabilizing forks, lower stabilizing fork and second extending drive means.
